(19) United States
(12) Patent Application Publication
(10) Pub. No.: US 2026/0332639 A1
(43) Pub. Date: Oct. 22, 2026

(54) SYSTEM AND METHOD FOR FILTERING COMMUNICATION AT A USER DEVICE

(71) Applicant: Honeywell International Inc., Charlotte, NC (US)

(72) Inventors: Muthuramalingam Manickam, Madurai (IN); Prabhavathy Moorthisamy, Bangalore (IN); Arivazhagan K, Madurai (IN); Tholkappian Chandrasekaran, Madurai (IN)

(21) Appl. No.: 19/180,139

(22) Filed: Apr. 16, 2025

(51) Int. Cl. H04L 9/40

(52) U.S. Cl. CPC H04L 63/1483; H04L 63/1425; H04L 63/20

(57) ABSTRACT

A system and method for filtering communication is disclosed. The system comprises a storage and at least one processor coupled to the storage. The processor is configured to receive a communication. Further, the processor is configured to retrieve phishing detection data from a cloud environment based on user activity data and a current location of a user device using an AI module, wherein the phishing detection data comprises historic phishing data and local trend data. Further, the processor is configured to calculate a probability of the communication being a phishing communication based on the retrieved phishing detection data. Further, the processor is configured to filter the received communication based on the calculated probability, wherein the filtering comprises at least one of blocking the received communication and displaying the received.

### TECHNICAL FIELD OF THE INVENTION

The present subject matter relates to user device security and, more particularly, to systems and methods for detecting and preventing phishing attacks in user devices.

### BACKGROUND OF THE INVENTION

Phishing is a type of cyberattack where attackers impersonate legitimate entities to deceive individuals into divulging sensitive information, such as usernames, passwords, banking data (banking credentials, OTPs, card details, etc.), or other personal data. These attacks are usually carried out through emails, websites, or text messages that appear to be from trusted sources.

Examples of phishing attacks may include, but are not limited to, Spear phishing (targeting individual), Vishing (when someone uses the phone to try to steal information), Email phishing, Watering hole phishing (a site a group of users tends to visit), Whaling (targets a senior executive), Deceptive phishing (to pretend they are with a real company), Angler phishing (fake social media posts to get people to provide login info or download malware), Smishing (through some form of a text message or SMS), HTTPS phishing (attackers impersonate a trusted website that uses the HTTPS protocol to deceive victims into providing sensitive information) etc.

Phishing poses several significant challenges for individuals, organizations, and society. With constantly changing tactics and emerging technologies, it makes it hard for users to stay updated on the latest phishing related threats. For instance, for users, distinguishing between legitimate and malicious emails is becoming increasingly difficult due to sophisticated social engineering tactics and the use of convincing, spoofed domains. Likewise, organizations face the daunting task of detecting and mitigating phishing attempts across diverse communication channels, while also training employees to recognize and report suspicious activities, making it a complex and resource intensive problem.

### SUMMARY OF THE INVENTION

The present subject matter provides systems and methods for filtering communications received at a user device. Aspects of the present subject matter facilitate in detection and prevention of phishing attacks in user devices.

In an embodiment, a method of filtering communication at a user device is disclosed. The method includes receiving a communication at the user device. Further, the method includes retrieving phishing detection data from a cloud environment based on user activity data and a current location of the user device, by an AI module, wherein the phishing detection data comprises historic phishing data and local trend data. Further, the method includes calculating a probability of the communication being a phishing communication based on the retrieved phishing detection data. The method further includes filtering the received communication based on the calculated probability, wherein the filtering comprises at least one of blocking the received communication and displaying the received.

In some embodiments, the filtering includes blocking the received communication when the calculated probability is above a first threshold. Further, the filtering includes displaying a warning message corresponding to the received communication when the calculated probability is above a second threshold and below the first threshold. Further, the filtering includes allowing the received communication as per a corresponding routine operation when the calculated probability is lower than the second threshold.

In some embodiments, the method includes determining the received communication to be the phishing communication when the calculated probability is above the first threshold. Further, the method includes transmitting information about the phishing communication to the cloud environment.

In some embodiments, wherein the user device is associated with an enterprise environment, the method further includes transmitting a security warning message to security centre of the enterprise environment, wherein the security warning message comprises information about the phishing communication.

In some embodiments, the phishing detection data retrieved from the storage further comprises global trend data, wherein the global trend data comprises data associated with one or more global events, wherein the calculating of the probability is further based on the global trend data.

In some embodiments, the retrieving further comprises transmitting the user activity data to an ML module deployed in the cloud environment, wherein the user activity data comprises data related to user activity associated with one or more applications of the user device. Further, the retrieving comprises receiving at least one of the historic phishing data and the local trend data from the ML module, wherein the ML module generates the historic phishing data from master historic phishing data stored in a storage of the cloud environment based on the user activity data received from the user device, wherein the ML module generates the local trend data from master local trend data stored in the storage of the cloud environment based on the user activity data received from the user device.

In some embodiments, the retrieving comprises transmitting location data comprising information about the current location of user device to an ML module deployed in the cloud environment. The retrieving further comprises receiving at least one of the historic phishing data and the local trend data from the ML module, wherein the ML module generates the historic phishing data from master historic phishing data stored in a storage of the cloud environment based on the user activity data received from the user device, wherein the ML module generates the local trend data from master local trend data stored in the storage of the cloud environment based on the user activity data received from the user device.

In an embodiment, a system for filtering communication is provided. The system comprises processor configured to receive a communication. The processor is further configured to retrieve phishing detection data from a cloud environment based on user activity data and a current location of a user device using an AI module, wherein the phishing detection data comprises historic phishing data and local trend data. Further, the processor is configured to calculate a probability of the communication being a phishing communication based on the retrieved phishing detection data. The processor is also configured to filter the received communication based on the calculated probability, wherein the filtering comprises at least one of blocking the received communication and displaying the received.

In yet another embodiment, a computer-readable medium having computer-executable instructions stored thereon is disclosed. The computer-executable instructions, when executed by a processor, cause the processor to receive a communication. Further, the computer-executable instructions further cause the processor to retrieve phishing detection data from a cloud environment based on user activity data and a current location of a user device, using an AI module, wherein the phishing detection data comprises historic phishing data and local trend data. Furthermore, the computer-executable instructions cause the processor to calculate a probability of the communication being a phishing communication based on the retrieved phishing detection data. Furthermore, the computer-executable instructions cause the processor to filter the received communication based on the calculated probability, wherein the filtering comprises at least one of blocking the received communication and displaying the received.

The systems and methods described above provide an efficient solution to detect/prevent phishing attacks using historical phishing data, user activity data, location of the user, current local trends and global trends related to phishing. The involvement of the user activity data helps in identifying user behavior driven phishing attacks with greater success and alert the user against such attacks.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1 illustrates an environment implementing a system for detection and prevention of phishing attacks, according to one or more embodiments of the present disclosure.

FIG. 2 illustrates a block diagram of the system for detection and prevention of phishing attacks, according to one or more embodiments of the present disclosure.

FIG. 3 illustrates a flowchart of a method 300 for filtering communication at a user device, according to one or more embodiments of the present disclosure.

FIG. 4 is a flowchart illustrating a method 400 for filtering communication at a user device, according to one or more embodiments of the present disclosure.

FIG. 5 is a flowchart illustrating a method 500 for filtering communication at a user device, according to one or more embodiments of the present disclosure.

FIG. 6 is a flowchart illustrating a method 600 for retrieving phishing detection data at a user device, according to one or more embodiments of the present disclosure.

FIG. 7 is a flowchart illustrating a method 700 for retrieving phishing detection data at a user device, according to one or more embodiments of the present disclosure.

FIG. 8 is a flowchart illustrating a method 800 for filtering communication at a user device, according to one or more embodiments of the present disclosure.

### DETAILED DESCRIPTION OF INVENTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

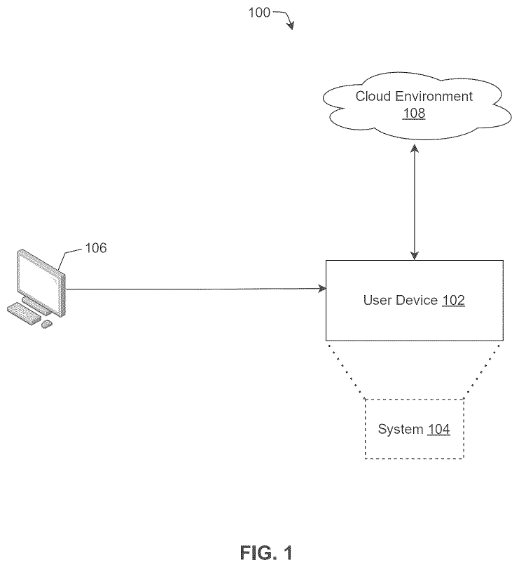

FIG. 1 illustrates an environment 100 implementing of a system 104 for detection and prevention of phishing attacks, according to one or more embodiments of the present disclosure. In an example, the system 104 may be implemented in a user device 102 to detect and prevent phishing attacks associated with a communication received at the user device 102, say, from a user device 106. In an example, the communication may be a text message, voice message, video message, email, social media notification, etc. sent by the user device 106 to the user device 102. In an example, the communication may be a phishing email pretending to be from a legitimate source (e.g., a bank or government agency) sent from a compromised or spoofed email server. Further, in an example, the communication may be from a fraudulent SMS gateway. In said example, malicious parties may use bulk SMS services to send fake messages with malicious links from the SMS gateway to users, where the fake messages are masked so as to appear to be from a courier services (e.g., “Your package is delayed. Click here to reschedule”). Further, in an example, the communication may be a notification from a compromised or a fake social media account. A hacker may be controlling a social media profile (e.g., a fake customer support account) may send phishing messages via direct messages, urging the user to visit a malicious link. Further, in an example, the communication may be a call from a spoofed customer support call centre. In said example, the scammers may use Voice over IP (VoIP) systems to make calls pretending to be from tech support or a financial institution, tricking the user into providing personal or banking information. In an example, the system 104 may be implemented by users, such as individuals, enterprises, corporate offices, educational institutions, research facilities, and government organizations, to filter out communications of the aforementioned type, thereby ensuing secure and safe usage of the user device(s) 102.

Examples of the user device 102 and the user device 106 may include, but are not limited to, a laptop, a desktop, a computer, a tablet, a smartphone, a server, an SMS gateway, an email server, and a palmtop.

In some embodiments, the system 104 may be deployed in the user device 102. For example, one or more components, such as a processor, memory, etc. of the user device 102 may operate together to function as the system 104 within the user device 102. Furthermore, one or more control options relating to the system 104 may be provided on the user device 102. The control options may facilitate (a) controlling the operations of the system 104, i.e., switching on/off the filtering of communications on the user device 102, (b) controlling types of communications, such as messages, emails, calls, etc., on which the filtering aspects of the system 104 are to be applied, and other control options as required. The control options, in an example, may be provided as a or through a systems application or a native phone application or through a third-party application.

In another example, the system 104 may be deployed as a cloud-based solution and the system 104 may be provided access to the user device 102. In yet another example, the system 104 may be deployed as a hybrid solution, i.e., with part implementation on the user device 102 and part implementation on the cloud.

In some embodiments, the system 104 may be implemented by a service provider to aid the detection and prevention of phishing attacks in user devices, such as the user device 102. As an example, there may be a plurality of the user device(s) implemented in an enterprise. Herein, the system 104 may be implemented in a central server of the enterprise and each of the plurality of the user device(s) may be connected to the system 104 for detection and prevention of phishing attacks in each of the user device(s). For the purposes of brevity and easy of explanation, a single user device 102 implementing the system 104 for detection and prevention of phishing attacks in said device 102 is shown in the FIG. 1.

The environment may further include a cloud environment 108. The cloud environment 108, amongst other things, may include one or more databases, processors, servers, etc. According to aspects of the present subject matter, data related to trending and historic events, data related to trending and historic phishing attacks, and data related to user behaviour and related phishing attacks may be stored in the one or more databases or storages provided in the cloud environment 108 as phishing detection data. In an embodiment, the system 104 may be coupled to the cloud environment 108 to retrieve information that helps in detecting and preventing the phishing attack at the user device 102.

In operation, the user device 102 may receive a communication from the user device 106. On receiving the communication, the system 104 may retrieve the phishing detection data from the cloud environment 108 to decide whether the received communication is malicious and an attempted phishing attack. According to aspects of the present subject matter, the determination of whether the received communication is a legit communication or is a phishing communication may be based on two factors, such as user activity data and the current location of the user device 102.

The system 104 may use the user activity data and user's current location to fetch historic phishing data and obtain local trend data from the cloud environment 108. In an example, the historic phishing data may include previously identified phishing patterns that align with the user's activity data. For instance, if a user frequently engages in online banking transactions, the cloud environment 108 may provide past phishing attempts that targeted banking services. Examples of which includes, such as phishing emails impersonating well-known banks, fake login pages designed to steal credentials, or SMS scams falsely claiming unauthorized transactions. Further, in an example, the user's current location may also be used to fetch historic phishing data from the cloud environment 108. For example, if a user is in an airport, the cloud environment 108 may provide reported phishing attempts targeting travellers, such as fake Wi-Fi login pages designed to capture sensitive credentials, fraudulent flight cancellation emails with malicious links, or deceptive messages impersonating travel booking platforms, etc.

Further, in an embodiment, the local trend data may be indicative of one or more activities going on in the current location of the user device 102 and one or more phishing trends associated with the said activities. For example, if a large e-commerce sale is ongoing in the user's location, the local trend data may include information about increased online shopping activity, leading to a rise in phishing attempts. These may include fraudulent discount offers, fake order confirmation emails containing malicious links, or counterfeit e-commerce websites mimicking well-known retailers. Further, if a natural disaster or public emergency has recently occurred in the location, phishing attempts may use the situation by impersonating relief organizations, soliciting fake donations, or sending fraudulent emergency alerts with malicious links.

Further, in an example, the local trend data may be indicative of general phishing trends going on in the current location of the user device 102. For instance, the local trend data may include a surge in phishing scams impersonating government agencies in that area, the local trend data may include fraudulent tax refund notifications, fake social security benefit emails, or scam messages posing as law enforcement agencies requesting sensitive information.

In an embodiment, the user activity data may be used to retrieve the local trend data from the cloud environment 108. For example, the user activity data may indicate that the user is frequently engages in cryptocurrency trading on various exchange platforms. Based on this activity data, the cloud environment may provide ongoing phishing trends targeting crypto users, such as fake login pages for popular crypto exchanges, fraudulent wallet recovery emails, or scam investment schemes circulating in online forums, etc. In another example, consider a user frequently visits job portals and applies for positions on platforms or company career pages. Based on the user activity data, the system 104 retrieves local trend data from the cloud environment 108, specifically focusing on phishing scams targeting job seekers, such as fake recruitment emails impersonating well-known companies, requests for upfront payments for job placements, or phishing websites mimicking job portals to steal login credentials, etc.

In an embodiment, the user activity data and the current location of the user device 108 both may be used to retrieve the local trend data from the cloud environment. For example, if a user frequently books ride-hailing services, such as Uber or Lyft) and is currently located near a busy airport. The cloud environment 108 may provide details of phishing scams targeting travellers in that airport area, such as fraudulent SMS messages pretending to be from ride-hailing apps, claiming that the user's ride has been cancelled or that a refund is being issued. In said example, the user's activity and the location of the user device 108 may align with a local trend, i.e., increased phishing attempts near the airport.

Once the phishing detection data is retrieved, the system 104 may calculate the probability of the received communication being a phishing attempt. The system 104 may analyse the communication's characteristics against the historic phishing data and local trends, using one or more algorithms to assign a probability score. Based on this probability, the user device 102 may filter the communication accordingly. If the likelihood of phishing is high, the system 104 may block the communication entirely. If the probability is moderate but still suspicious, the system 104 may display a warning to alert the user before allowing access.

According to the aspects of the present disclosure, the system 104 enhances phishing detection by utilizing user activity data and local trends. The system 104 utilizes cloud-based data to provide real-time updates on phishing patterns, ensuring detection of both global and localized threats. By calculating the probability of a phishing attempt, the system 104 may block, warn, or allow communications based on severity, offering proactive, scalable, and adaptive protection. The present solution improves user experience, and provides customized, location-specific defense against phishing attacks.

For example, a user named Alice, is working remotely in San Francisco on her laptop which may a user device 102. Alice receives an email from a sending device claiming to be from her bank, urging her to click on a link to verify her account details. The system 104 retrieves phishing detection data from the cloud environment 108, considering Alice's recent activity and location. Since the cloud database has logged a surge in phishing attempts in San Francisco, where attackers are sending fake bank verification emails, the system 104 matches Alice's email to this ongoing phishing trend. Based on its probability scoring algorithm, the system 104 determines that the email is highly likely to be phishing and blocks it, preventing Alice from falling victim to the scam.

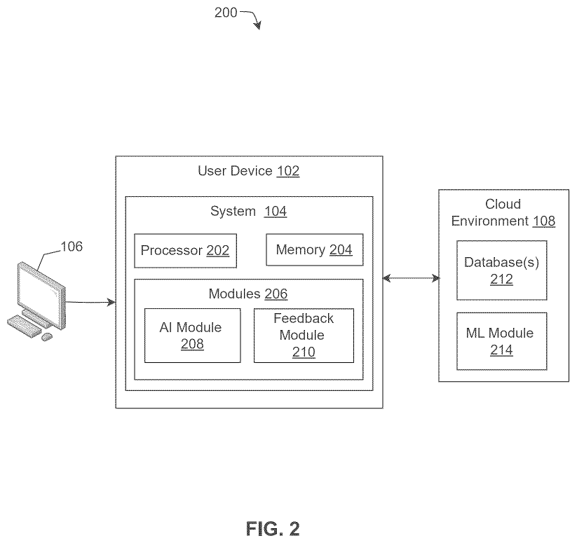

FIG. 2 illustrates a schematic block diagram of a system 104 for detection and prevention of phishing attacks, according to one or more embodiments of the present disclosure. In an embodiment, the system 104 may include a processor 202, memory 204 and module(s) 206. The modules(s) may further include an AI module 208 and a feedback module 210. The system 104 may be coupled to a cloud environment 108. The cloud environment may further include database(s) 212 and a Machine Learning (ML) module 214. In an embodiment, the system 104 may be connected to a user device 106 to receive a communication.

The system 104, upon receiving a communication from the user device 106, initiates the filtering process to determine whether the communication is potentially a phishing attempt, utilizing various components and modules of the system 104. In an example, the filtering may be understood as the process of analyzing incoming communications (such as emails, messages, or notifications) to determine whether said communications may be phishing attempts. Accordingly, the communication will be filtered for either blocking or displaying on the user device 102 or displaying with a warning message.

To facilitate this filtering process, the system 104 may be coupled to the cloud environment 108, which further includes databases and learning modules. The system 104 may retrieve phishing detection data from the cloud environment 108. Based on this phishing detection data, the system's components/modules analyse and identify potential phishing threats, preventing such communications from being displayed on a user device 102. Further, the system 104 may provide feedback to the cloud environment 108 regarding the identified phishing communication, aiding in continuous training and improvement of the detection models. Further, detailed explanation of system 104's components and modules, along with the cloud environment 108, are provided herein below.

The processor 202, in some examples, may be implemented or realized as general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In some examples, the processor 202 may be realized as microprocessors, controllers, microcontrollers, or state machines. In some examples, the processor 202 may be realized as a combination of computing devices, such as, a combination of digital signal processors and microprocessors, a plurality of microprocessors, one or more microprocessors in conjunction with a digital signal processor core, or any other such combination/configuration. In some embodiments, one or more processors, such as the processor 104 or equivalents thereof, may be provided for performing operations thereof, as described herein.

The memory 204 comprises one or more non-transitory computer-readable storage media, including but not limited to volatile storage media such as random-access memory (RAM), registers, cache, etc., as well as non-volatile storage media such as read-only memory (ROM), hard disk drives, solid-state drives, flash memory, optical storage devices, and so forth. Furthermore, the memory 204 may encompass computer-readable storage media that are distributed across a plurality of physical computing devices connected via a network, such as storage clusters within public, private, or hybrid cloud-based environments. In some embodiments, the memory 204 may be provisioned with software components that facilitate the system 104 in executing functionalities disclosed herein. These software components typically consist of program instructions executable by the processor 202, organized into software applications, virtual machines, software development kits, toolsets, or similar structures. Furthermore, the memory 204 may be configured to maintain data within one or more databases, file systems, or equivalent data structures. The memory 204 may also be implemented in other forms and/or configured to store data using alternative methods. In some examples, the memory 204 may include user activity data and location of the user device 102.

In an embodiment, the module(s) 206, amongst other things, include routines, programs, objects, components, data structures, etc., which perform particular tasks or implement data types. The module(s) 206 may also be implemented as, signal processor(s), state machine(s), logic circuitries, and/or any other device or component that manipulate signals based on operational instructions.

Further, the module(s) 206 can be implemented in hardware, instructions executed by a processing unit, or by a combination thereof. The processing unit can comprise a computer, a processor, such as the processor 202, a state machine, a logic array or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the module(s) 206 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

In an embodiment, the module(s) 206 may include the AI module 208. The AI module 208 may be understood as a routine or service or program implementing one or more trained models. Herein, the AI module 208 may be configured to implement one or more AI techniques using one or more trained models for processing phishing detection data that is provided as an input to the AI module 208. Accordingly, by application of the one or more AI techniques on the phishing detection data, the AI module 208 may calculating a probability of the communication being a phishing communication and said output is provided to an entity or component of the system, such as the system 104, in conjunction with which the AI module 208 is implemented.

In some embodiments, the AI module 208 may be implemented on one or more processors, such as the processor 202 described above. In some embodiments, although shown distinct to the processor 202, the AI module 208 may be implemented using or as a part of the processor 202. Furthermore, any types of micro-processors, controllers, processors including graphical processing units and central processing units, routines, programs, connections, may be implemented for realizing the AI module 208. In the context of the present disclosure, without limitation, the AI module 208 may be configured process the phishing detection data to calculate a probability for any communication being the phishing communication.

In an embodiment, the module(s) 206 may include the feedback module 210. In an embodiment, the feedback module 210 may provide an input to the ML module 214 when the system 104 may identify any received communication as the phishing communication. The ML module 214 may accordingly perform training based upon the input received from the feedback module 210. In an embodiment, the feedback module 210 may provide the input to processor 202 are further configured to provide the data to ML module 214 for training.

In an embodiment, the cloud environment 108 includes the database(s) 212. In an example, the database 212 may include data related to historic phishing data, current local trends in the phishing, current global trends in the phishing. In an embodiment, there may be different databases for storing each of the historic phishing data, current local trends, and current global trends. In some embodiments, the ML model 214 may be coupled to the database(s) 212 and get trained based upon the data received from said database(s) 212. The one or more processors are further configured to detect at least one update in the database(s) 212, where the at least one update corresponds to historic phishing data, current local trends, or current global trends associated with the communication and user activity data.

The one or more processors are further configured to provide the detected at least one update in the database(s) 212 as an input to the AI module 208. The AI module 208 may be configured to calculate the probability of the communication being a phishing communication based upon said input. The one or more processors are further configured to receive the calculated probability as an output from the AI module 208 for either displaying or blocking the received communication on a user device 102.

The cloud environment 108 includes the ML module 214 (or “the model 214”) may be understood as a machine learning model developed through a training process utilizing training data including, but not limited to, historic phishing trends, current global and local trends in phishing. Herein, the model 214 is trained and may be learning in real time for the phishing related data that may be later used by the system 104 for detection and prevention of fishing attack. The ML module 214 may train itself based on previously observed patterns of phishing attempts, such as types of messages, tactics used (like fake login pages, suspicious links, or fraudulent email addresses), and the type of victims targeted. Further, the model 214 is trained using current global and local trends refer to ongoing or recent phishing activities happening worldwide and in specific regions. In an example, global trends may include large-scale phishing campaigns targeting popular organizations, like phishing emails pretending to be from large tech companies. Examples of global trend may include Wimbledon, Olympics, Elections, etc. Further, in an example, the local trends may be based on regional phishing activities. For example, in a specific city or country, attackers may be sending out fake messages about local events, like pretending to be from a regional service provider or a government agency. If there's a recent spike in said types of attacks in a specific area, the model 214 may use this local trend data to adjust its phishing detection for that area.

In operation, the system 104 in the user device 102 may receive a communication. In an example, the communication may be a text message, an audio, a video, one or more social media updates, an email, a voice call, a video call, etc. received by the user device 102 from the user device 106. Upon receiving the communication, the processor 202 may be configured to process the communication using the AI module 208 to determine whether the communication is a phishing communication or a normal communication. For making this determination, the processor 102 may be configured to communicate with the cloud environment 108. Herein, the processor 202 may transmit user activity data and a current location of the user device 102 to the cloud environment 108 and may receive phishing detection data in return from the cloud environment 108.

In an example, the user activity data may be understood as data pertaining to the user's usage of the user device 102. For example, the user activity data may include, but is not limited to, the user's browsing history, frequently visited websites, login attempts, social media activity, search queries, shopping behaviour and interests, interaction habits with the user device 102's applications, such as emails or messages of the user device 102. In an example, the user device 102 may determine its current location using one or more location determining techniques, such as GPS-based tracking, Wi-Fi and network-based location tracking, IP address geolocation, device sensors and Bluetooth beacons, etc. In an embodiment, the user activity data and the current location of the user device 102 may be stored in the memory 204 by the processor 202. The phishing detection data may be understood as data indicative of various phishing attacks specific to geography and user's device usage habits, which may be used by the system 104 in its analysis of determining whether the received communication is a phishing communication or not. Detailed explanation of the phishing detection data is provided below.

In an example, the processor 202 may be configured to transmit the user activity data to an ML module 214 deployed in the cloud environment 108. In response, the ML module 214 may provide historic phishing data and local trend data as part of the phishing detection data to the processor 202. The historic phishing data may be understood as previous incidents and patterns of phishing attacks recorded over time by the ML module 214 in the databases(s) 212 of the the cloud environment 108. In the current example, the historic phishing data may include previously identified phishing patterns relevant to the user's activity data and/or the location of the user device 104. In an embodiment, the local trend data may refer to ongoing one or more activities or events specific to the user device 102's location. In some embodiments, the local trend data may also include phishing trends specific to the location of the user device 102. Furthermore, in some embodiment, the local trend data may include information about correlation between the one or more activities or events and the regional phishing trends. The historic phishing data and the local trend data may be stored in the database(s) 212. The database(s) 212 may be updated in real time or periodically, by the ML module 214 which may be continuously learning and getting trained based upon recent activities and the phishing trends locally.

To explain the above with an example, consider a case where a user frequently accesses online banking portals, e-commerce websites, or social media platforms on a user device, such as the user device 104. Herein, the system 104 may analyse these user activities and may store information about the aforementioned activities as the user activity data. Now, when a communication is received at the user device 102, the system 104 may use the aforementioned user activity data and connect with the cloud environment 108 to fetch whether any prior phishing attempts were linked to such websites or platforms. For example, a user regularly logs into their online bank account, visits popular shopping websites, and frequently checks their social media. The system 104 may keep track of these activities as part of the user activity data and stores in the memory 204. If the user has recently logged into their bank account and received an email that appears to be from the bank, the system 104 may check if similar phishing patterns have been reported for this bank or other banks.

Similar to above example, system 104 may use other user activity data, such as user's browsing history, social media activity, interaction habits with the user device 102's applications, such as emails or messages of the user device and connect with the cloud environment 108 to fetch whether any prior phishing attempts were linked to any of the provided user's browsing history or social media activity.

Further, in an example, the user activity data may be used to retrieve the local trend data from the cloud environment 108. For example, the user activity data may be such as browsing for local events or shopping promotions. If the user is looking up a local music festival, said user activity data may be sent to the cloud environment 108. Upon receiving the user activity data, the cloud environment 108, based on historic phishing data stored in its databases 212, may recognize that phishing patterns often target users engaging with event-related activities. For example, if the user is searching for the local music festival, the cloud environment 108 may provide local trend data about phishing scams targeting concertgoers, such as fake ticket sales, fraudulent websites selling tickets for the event, offering tickets at a price that seems too good to be true, fraudulent booking websites posing as official booking platforms for the event, designed to trick users into entering their personal details under the guise of securing a reservation, etc.

In an example, in response to the user activity data, the cloud environment 108 may provide the processor 202 with local trend data. In one example, the local trend data may be associated with activities similar to those of the user and includes phishing patterns related to these activities. For example, if a user frequently logs into their online banking portal and subsequently checks their email for transaction alerts, the system 104 may track these activities as part of the user activity data. Upon receiving this data, the cloud environment 108, based on historic records stored in its databases 212, may identify that other users exhibiting similar online banking and email-checking behaviours have been targeted by specific phishing scams. For instance, the cloud environment 108 may retrieve historic phishing data indicating that users with this activity pattern were attacked with phishing emails mimicking bank notifications, emails that urge users to urgently verify account details or reset their passwords via links leading to fake login pages. Additionally, the cloud environment 108 might have recorded SMS phishing patterns where fraudulent messages, disguised as alerts from the bank, prompted users to confirm suspicious transactions. The cloud environment 108 may provide the system 104 with activities similar to the user's and their associated phishing patterns as phishing detection data.

In an example, phishing patterns refer to specific characteristics or schemes used in previous phishing attempts, such as fake login pages, suspicious email attachments, domain spoofing, or messages designed to impersonate legitimate organizations. For example, the phishing pattern of fake login page, where scammers send an email that appears to be from user's own bank, urging to log in to fix an issue with user's account. The email contains a link that seems to take user to his bank's website, but it leads to a fake page designed to steal the user's login details. Another example is suspicious email attachments, where an email seems to be from a trusted source, like a colleague or friend, with an attachment that claims to be a funny video or important document. When opened, the attachment could contain harmful malware. Further, in an example, domain spoofing is another scheme where scammers send emails that look like they come from well-known companies, such as Amazon, but the email address is slightly altered may be just one letter off from the official domain, hoping to deceive user into believing it's legitimate. Further, an example of impersonating legitimate organizations as a phishing scheme, where scammers send emails pretending to be from companies like user's cell phone provider or an online store, asking user to verify personal details or make a payment. These are all examples of phishing patterns, used by scammers to impersonate trusted entities and steal personal information. The cloud environment 108 may help in identifying such patterns by maintaining the database(s) 212 of phishing scheme, enabling the system 104 to analyze whether the received communication matches any previously recorded phishing schemes.

Further, the processor 202 may transmit location data comprising information about the current location of user device 102 to an ML module 214 deployed in the cloud environment 108. In response of sending the current location of user device 102, the ML module 214 may provide the historic phishing data and local trend data as part of the phishing detection data to the processor 202. The historic phishing data and the local trend data may be stored in the database(s) 212. The database(s) 212 may be updated in real time or periodically, by the ML module 214 which may be continuously learning and getting trained based upon recent activities and the phishing trends locally.

For example, a phishing scam targeting users in New York City, where attackers are sending fake delivery notifications pretending to be from a well-known local courier service. The messages contain a fraudulent link asking users to enter personal details to “reschedule” a package delivery. If multiple users in New York City report or interact with these phishing messages, the cloud environment 108 collects and updates this as a new local phishing trend. The system 104 based upon current location of the user device 104 may retrieve the local trends in the New York City from the cloud environment 108 to identify that said communication is one of the said ongoing local phishing trend in the city.

Further explained an example where the current location of the user device 102 may be used by the cloud environment 108 to provide the historic phishing data to the processor 202. For example, suppose a user in Los Angeles receives a suspicious email that appears to be from a local utility provider, asking them to click a link to resolve an overdue payment. The processor 202 transmits the current location of the user device 102 which is Los Angeles to the ML module 214 in the cloud environment 108. The cloud environment 108, in response, checks its historic phishing data database(s) 212 for any known phishing incidents that have been reported in Los Angeles related to utility companies or similar tactics. The historic phishing data could include past incidents where phishing emails were sent to users in Los Angeles, impersonating local service providers and attempting to steal payment information. For instance, the cloud environment 108 may retrieve past records of phishing attempts where attackers disguised themselves as utility companies and sent fraudulent emails to users in Los Angeles, urging them to click on links or enter payment details. Said historic phishing data may be provided to the processor 202 to compare the current communication to the historic phishing attempts from the Los Angeles area, in order to determine if the communication is likely to be part of an ongoing phishing scam in that location.

Further, in the embodiment, said phishing detection data may be retrieved by the AI module 208 to analyse the communication being the phishing communication from the processor 202. Further, in an embodiment, the phishing detection data may be directly retrieved by the AI module 208 from the cloud environment 108. In an embodiment, the AI module 208, upon receiving the phishing detection data, may calculate a probability of the communication being a phishing communication.

Consider an example for the AI module 208 receiving phishing detection data from the cloud environment 108 for calculating the probability of the communication being a phishing communication. In said example, suppose the system 104 may receive a communication that claims to be from a well-known local restaurant offering a special discount voucher. The AI module 208 extracts key features from this communication such as the sender's email address, the URL in the hyperlink, and the message content. The AI module 208 may then perform a twofold comparison of the communication, i.e., against historic phishing data and against local trend data. The AI module 208 may check if the features of the received communication match patterns from past phishing attempts, for example, whether the sender's address resembles those used in previous phishing scams or if the URL structure is similar to known fraudulent links. Further, the AI module 202 may verifies if the characteristics of the communication align with current local phishing trends, for example, if there is a recent increase in phishing attempts impersonating local restaurants offering discount vouchers. If both comparisons indicate significant similarity to known phishing patterns and ongoing local phishing trends, the AI module 208 may calculate the probability of the communication being a phishing communication.

Further, the received communication may get filtered based on the calculated probability. In an embodiment, the AI module 208 may send the calculated probability for said communication to the processor 202 for filtering. The processor 202 may be configured to compare the calculated probability with one or more predefined thresholds. For example, the processor 202 may be configured to block the received communication when the calculated probability is above a first threshold. For example, upon receiving a new email with a subject line stating, “Immediate Action Required: Reset Your Password,” the AI module 208 may analyze the communication and calculate a probability score of 92%, indicating a strong likelihood of phishing. The processor 202 may then compare this probability score with a predefined first threshold of 90%. Since the calculated probability exceeds the first threshold, the processor 202 may automatically block the received communication, preventing it from reaching the user's inbox.

In an embodiment, the blocking of the communication may be associated with a message for the user of the user device 102. The message may be used to notify that a communication has been blocked. For example, the message associated with the blocked communication may read, “Message Blocked: Potential Phishing Attempt Detected” or “Security Alert: This Communication Has Been Blocked.” Further, in an example, the message may also include additional details, such as the reason for blocking or the specific characteristics that triggered the block.

Further, in an embodiment, the processor 202 may be configured to display a warning message corresponding to the received communication when the calculated probability is above a second threshold and below the first threshold. For example, the warning message may read, “Warning: Potential Phishing Attempt Detected!” or “Caution: Unusual Activity Detected,” alerting the user to the possibility of a phishing attack. Further examples of warning messages may include, “Phishing Risk Detected: Proceed with Caution” or “Security Alert: Possible Phishing Message,” which advise the user to verify the legitimacy of the communication before interacting with any content. Further, in an example, the message may also be a more specific warning, such as “Suspicious Email Detected!” indicating that the system 104 has identified suspicious elements, prompting the user to exercise caution.

In an example, the message may be displayed on the user device interface 102. For example, the AI module 208 may analyze a communication and calculate a probability score of 75%, indicating a potential phishing attempt. The processor 202 may then compare this probability score with a predefined second threshold of 70% and a first threshold of 90%. As the calculated probability is above the second threshold but below the first threshold, the processor 202 may display a warning message to the user, alerting them that the email could be a phishing attempt and advising caution before interacting with any links or attachments.

Further, in an embodiment, the processor 202 may be configured to allow the received communication as per a corresponding routine operation when the calculated probability is lower than the second threshold. For example, upon receiving an email from a known contact with a subject line such as “Meeting at 3 PM” and an attachment that matches the user's typical document formats (user activity data), the AI module 208 calculates a probability score of 30% for the email communication, which is lower than the predefined second threshold of 50%. As the calculated probability is below the second threshold, the processor 202 may allow the email to be delivered and processed as part of the routine operation, with no additional warning or filtering. The email may be considered as a legitimate communication, and the user can open the attachment without further interference from the system 104.

In an embodiment, once the processor 202 may determine that the received communication to be the phishing communication when the calculated probability is above the first threshold, the processor 202 may trigger the process of feedback. The processor 202 may send the details of the identified phishing communication to the feedback module 210. The feedback module 210 may be configured to transmit information about the phishing communication to the cloud environment 108. Once the feedback module transmits details of the detected phishing communication to the cloud environment 108, the ML module 214 in the cloud environment 208 may process the data of the communication to identify patterns and trends. For example, the ML module 214 may examine several characteristics of the phishing communication, such as the subject line, sender address, embedded links, and even linguistic patterns in the text. By analysing these patterns, the ML module 214 may learn to recognize new types of phishing scheme that were previously unknown to the ML module 214. In an embodiment, the ML module 214 may update its models to incorporate new phishing patterns based upon number of phishing communications received from the system 104.

Further, in an embodiment, the user device 102 may be associated with an enterprise environment. In scenarios where the calculated probability of the received communication is above a second threshold and below the first threshold, the system 104 may be configured to perform one or more actions. In an embodiment, the processor 202 or the system 104 may not only display the warning message on the user device 102 corresponding to the received communication but also may trigger further security response. For example, the system 104 may transmit a security warning message to security centre of the enterprise environment. In an example, the security centre of the enterprise environment may be a central system monitoring one or more such systems 104 running in the enterprise environment. In an example, the security warning message may comprise information about the phishing communication received at at least one system 104. Said security warning message sent to the security centre may contain critical information about the phishing communication, such as the sender's details, any suspicious links or attachments, and the likelihood of the message being a phishing attempt, features of the phishing communication. In an example, the security centre may use this information to perform further analysis and take necessary actions, such as alerting the IT team, blocking the sender, or running additional scans on other user devices in the enterprise environment.

For example, an employee at a large corporation receives an email on their user device 102. The email claims to be from a well-known vendor and includes a link asking the employee to click on it to “verify” an order. First, the system 104 analyses the email and determines that the calculated probability of it being a phishing attempt is moderate, meaning the probability is above the second threshold but below the first threshold. As a result, the processor 202 displays a warning message to the employee on the user device 102, alerting them that the email could potentially be a phishing attempt but is not definitively one. The employee is advised to be cautious and not click on any links in the email without verifying its legitimacy. The system 104 may also suggest verifying the email's authenticity with the vendor directly. At the same time, as the system 104 may be configured to be within the enterprise environment, the system 104 transmits a security warning message to the enterprise's security centre. Said message includes key information about the phishing communication, such as the email's sender address, subject line, the specific link contained in the email, and a calculated risk score indicating how likely it is to be a phishing attempt. For example, the warning message sent to the security centre may be sender: phishing@fake-vendor.com, subject: Urgent Order Verification Needed, Link Contained in Email: http://maliciouslink.com/verify_order, Calculated Risk Score: 70% (Moderate Risk), Phishing Patterns Detected: Suspicious domain, urgent language, misleading link.

In an embodiment, the security centre upon receiving the warning message and the associated information, may immediately logs the potential threat. Further, in an example, the security team may review the message and compare it against other reports from users to check if there are patterns indicating an ongoing phishing attack targeting other employees in the enterprise environment. In some embodiments, the security team may use the information in the warning message to block the sender's email address across the enterprise's email servers, preventing further phishing attempts from that source.

Further, in an embodiment, the phishing detection data retrieved by the processor 202 from the cloud environment 108 may further comprises global trend data. In an example, the global trend data comprises data associated with one or more global events. In an embodiment, the AI module 108 may calculate the probability of the communication being a phishing communication may be based on the global trend data.

For example, during a global pandemic, the attackers may capitalize on public fear and urgency by sending phishing emails claiming to offer free vaccines, medical supplies, or government relief funds. Said emails often contain malicious links or request personal and financial information, tricking users into providing sensitive data. Further, in an example, during high-profile international sporting events like the FIFA World Cup, cybercriminals may launch phishing campaigns targeting fans. Common scams may include fake ticket sales promising exclusive access to matches, fraudulent lottery winnings claiming the recipient has won a free trip or VIP experience, scams involving fake hospitality or travel packages, luring users into making payments for non-existent services.

The ML module 214 in the cloud environment 108 may learn about said global phishing trends and get trained in real time. In an embodiment, the global trend data related to phishing may be stored in the database(s) 212 in the cloud environment 108. Once the processor 202 may share the user activity data and the current location of the user, the ML module 214 may retrieve the global trend data from the database(s) 212 for providing to the processor 202.

In one embodiment, upon receiving the communication at the user device 108, the processor 202 may be configured to identify one or more characteristics of the received communication. In an example, the characteristics of the communication may include, but are not limited to, the sender's email address, embedded URLs, message content, and the presence of attachments. Further, the processor 202 may filter the user activity data based upon the identified one or more characteristics of the received communication.

For example, once the one or more characteristics are identified, the processor 202 may filter the user activity data to extract only relevant portions that align with the nature of the received communication. Said step ensures that only contextually significant user activity data is considered for further phishing analysis by the system 104. For example, if the received communication appears to be banking-related, the processor 202 may filter the user activity data to include recent login attempts to online banking portals, interactions with past banking-related emails, and prior clicks on financial service links. Similarly, if the communication pertains to an e-commerce platform, the processor 202 may filter user activity data related to browsing history for online shopping, previous order confirmation emails, and interactions with promotional discount offers. The user activity data may be present and retrieved from the memory 204.

Once the user activity data is filtered based on the identified characteristics of the received communication, the processor 202 may transmit the filtered user activity data to the cloud environment 108. The cloud environment 108, in response, may retrieve historic phishing data and local trend data relevant to the filtered user activity data. Further, the processor 202 may be configured to send the communication along with the historic phishing data and local trend data relevant to the filtered user activity data to the AI module 208 to analyse the communication being a phishing communication. The AI module 208, upon receiving the communication at the user device 102, may filter the communication by analyzing metadata, inspecting embedded links, scanning for malicious attachments, and recognizing patterns indicative of phishing attempts associated with said communication.

For example, if the communication is a text message claiming to be from “Express Delivery Service,” urging the user to reschedule a package delivery by clicking on a provided link, the processor 202 may extract key attributes such as the sender's name, the urgency of the message, and the embedded URL. Upon identifying these characteristics, the processor 202 filters the user activity data to focus on interactions relevant to delivery services. If the user frequently shops online and has recently tracked orders or interacted with legitimate courier services, the system 104 retrieves relevant browsing history, past order confirmations, and previous delivery notifications received by the user. Said refined filtering process ensures that phishing detection mechanisms are based on highly relevant user interactions rather than all the generic user activity patterns.

After the user activity data is filtered, the processor 202 transmits it to the cloud environment 108. The cloud environment 108 then retrieves historic phishing data specific to fraudulent delivery scams, such as previously reported phishing attempts where attackers impersonated courier services using similar messaging tactics and deceptive links. Further, the cloud environment 108 analyses the filtered user activity data to determine any emerging phishing trends. For instance, if multiple users with similar online shopping behaviors have reported phishing messages disguised as fake delivery notifications, the ML module 214 in the cloud environment 108 updates this pattern as a new phishing trend. The cloud environment 108 then transmits the relevant historic phishing data and local trend data to the AI module 208 for further evaluation.

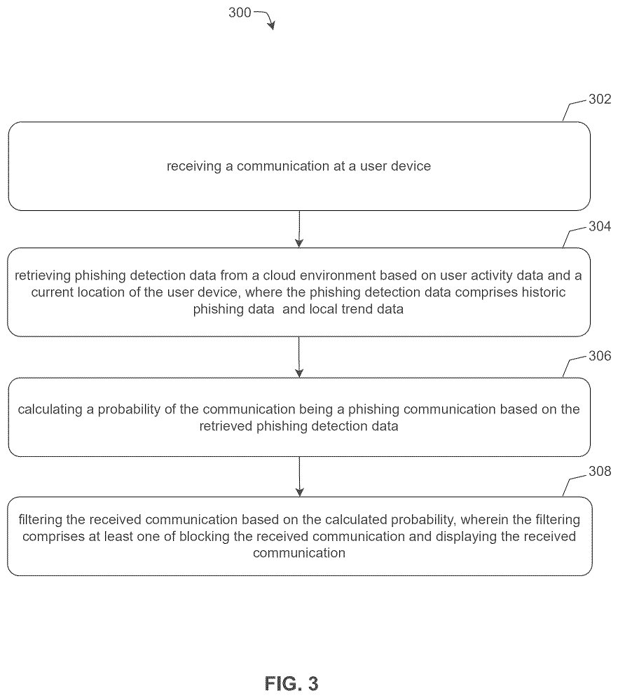

FIG. 3 illustrates a flowchart of a method 300 for filtering communication at a user device 102, according to one or more embodiments of the present disclosure. In an example, the communication may be a text message, voice message, video message, email, social media notification, etc. sent by the user device 106 to the user device 102. In an example, the communication may be a phishing email, message from a fraudulent SMS gateway, a notification from a compromised or a fake social media account, a call from a spoofed customer support call centre. The steps of the method 300, described in connection with the embodiments disclosed herein, may be embodied directly in hardware, in firmware, in a software module executed by a system, or in any practical combination thereof. In some embodiments, the method 300 may be implemented by the system 104 which may be implemented by users, such as individuals, enterprises, corporate offices, educational institutions, research facilities, and government organizations, to filter out communications of the aforementioned type, thereby ensuing secure and safe usage of the user device(s) 102.

In an example, the method 300 may commence at step 302 when communication is received at the user device 102. As mentioned above, the communication may be received from user device 106. Upon receiving the communication, it may be checked if it is associated with any phishing attempt. In order to check the communication to be a phishing attempt, one or more steps of the method 300 may be performed.

At step 304, the method 300 includes retrieving phishing detection data from a cloud environment 108 based on user activity data and a current location of the user device. In an embodiment, the phishing detection data comprises historic phishing data and local trend data. Upon receiving the communication, the user activity data and the current location of the user device 102 may be transmitted to the cloud environment 108. The cloud environment 108, based upon said user activity data and the current location of the user device 102 may provide the historic phishing data and local trend data to the processor 204. Said phishing detection data which include historic phishing data and local trend data may be provided to the AI module 108 for further checking and analysing whether the received communication to be the phishing attempt or not. In an example, the user activity data and the current location of the user device 102 may be retrieved from the memory 204. The step 304 may be performed by the processor 202, in an example.

At step 306, the method 300 may include calculating a probability of the communication being the phishing communication based on the retrieved phishing detection data. In an embodiment, the AI module 108 may compare the received communication with the received historic phishing data and the local trend data using one or more algorithms and matching techniques. The AI module 108 may calculate the probability of the communication being the phishing communication based on how closely the communication matches both the received historic phishing data and the local trend data.

In the embodiment, calculating a probability of the communication being the phishing communication based on both historic phishing data and local trend data may enhance the accuracy of phishing detection. By having access to both datasets, the AI module 108 may detect phishing communications that resemble past attacks while also identifying evolving threats that target specific locations or user groups. For example, if a user receives an email appearing to be from their bank, requesting them to verify their account by clicking on a link, the AI module 108 first checks whether similar phishing emails exist in the historic phishing data. If a match is found, the probability of phishing is increased. The AI module 108 then cross-references the email with the local trend data to determine whether phishing emails impersonating the same bank have been recently reported in the user's region. If such cases exist, the phishing probability is further increased.

To perform this comparison, the AI module 108 may utilize multiple algorithms and matching techniques. For example, string matching techniques, such as Levenshtein Distance, may identify slight variations in phishing messages while still detecting similarities. Further, machine learning models, such as Support Vector Machines (SVM) or Random Forest, may analyse email metadata, message content, and sender details to classify emails as phishing or legitimate. Further, deep learning models, such as BERT, may analyse the context of the message and detect phishing attempts that use sophisticated wording to evade detection. Further, graph-based analysis may track relationships between phishing domains and previously identified phishing campaigns, allowing the AI module 108 to flag emails originating from known fraudulent sources.

By continuously updation in the local trend data and using it in conjunction with the historic phishing data, the AI module 108 may ensures that phishing detection remains effective against both previously known phishing attempts and newly emerging threats. This allows the method to dynamically adapt to changing attack patterns, ensuring higher accuracy in identifying phishing communications.

At step 308, the method 300 includes filtering the received communication based on the calculated probability, wherein the filtering comprises at least one of blocking the received communication and displaying the received. The step may be performed by the processor 202 in the system 102. Once the AI module 108 calculates the probability of the received communication being a phishing communication, the probability score is sent to the processor 202. The processor 202 then compares this probability score with predefined threshold levels set within the system 104. These threshold levels determine the appropriate action to be taken for the received communication. If the probability score exceeds a certain high threshold, the communication entirely may be blocked entirely, preventing it from reaching the user's inbox. If the probability score falls within a medium-risk range, the communication may be displayed on the user device 102.

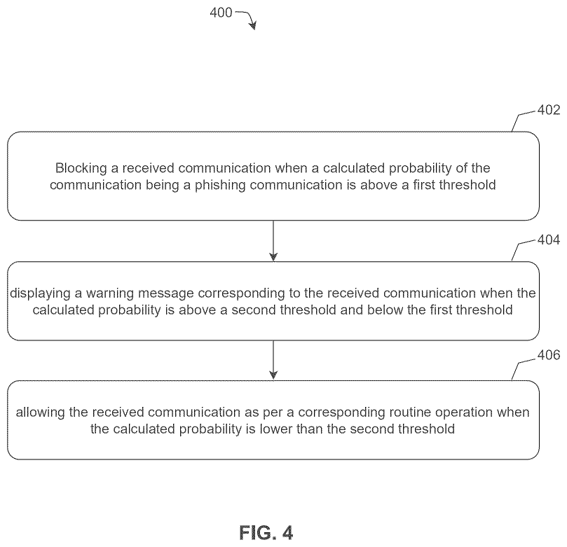

FIG. 4 is a flowchart illustrating method 400 for filtering communication on a user device, in accordance with one or more embodiments of the present disclosure. In this embodiment, the method may define multiple threshold levels, each associated with a specific action to be performed by the processor 202 based on the calculated probability of the received communication being phishing. Said predefined thresholds may be used to determine whether the communication should be blocked, flagged with a warning, or allowed to pass through without restriction. The steps of the method may be performed by the processor 202 in communication with the memory 204.

At step 402, the method may include blocking the received communication when the calculated probability is above a first threshold. In an example, blocking of the communication may ensure that the communication does not reach the user's device 102, preventing potential harm such as credential theft, malware infections, or financial fraud, etc. In case the calculated probability is not above the first threshold, the method may proceed to step 404.

At step 404, the method may include displaying a warning message corresponding to the received communication when the calculated probability is above a second threshold and below the first threshold. This means that if the phishing probability is moderate, the method may not block the communication entirely but instead alerts the user with a warning. In case the calculated probability is not above the second threshold, the method may proceed to step 406.

At step 406, the method may include allowing the received communication as per a corresponding routine operation when the calculated probability is lower than the second threshold. This means that if the probability score is below the second threshold, the method may consider the communication to be safe and processes it normally without blocking or displaying any warnings to the user.

For example, if an email is assigned a probability score of 90% based on its similarity to historic phishing data and local trend data, and if the first threshold may be predefined as 85%, the communication may be automatically blocked and prevented for displaying on the suer device 102. In an example, another email has a probability score of 60% computed by the AI module 108, which is above second threshold and below the first threshold, the method may allow the email but flag it with a warning, such as “This email may be a phishing attempt. Proceed with caution.” Further, in an example, if an email has a probability score of 10%, which is below the predefined second threshold level, the communication may be delivered to the user without restrictions.

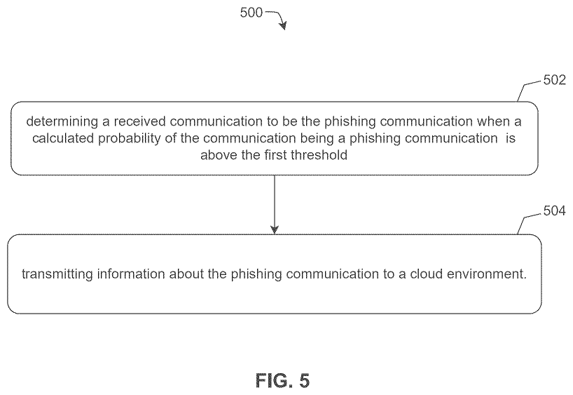

FIG. 5 is a flowchart illustrating a method 500 for filtering communication at a user device, according to one or more embodiments of the present disclosure. In the present embodiment, the method involves providing feedback to the cloud environment 108, in case the communication may be identified as phishing communication. The method may be performed by the processor 202 and the feedback module 210.

At step 502, the method 500 may include determining the received communication to be the phishing communication when the calculated probability is above the first threshold.

At step 504, information about the phishing communication may be transmitted to the cloud environment. The information sent to the cloud may include key details such as the sender's email address, message content patterns, detected phishing indicators, and any associated malicious links or attachments. The cloud environment 108 may then processes this data, updating phishing detection models in the database(s) 212 and for training the ML module 214.

Consider a user receiving an email from support@secure-payments.com with the subject “Immediate Action Required: Update Your Payment Information”. The email may include a link to a fraudulent website designed to steal user credentials. The calculated probability score is, say 92%, which exceeds the first threshold, e.g., 85%. Based on this, the processor 202 may determine that the email is a phishing communication. Following this determination, the processor 202, with the help of the feedback module 210, may transmit key details of the phishing email to the cloud environment 108. The cloud environment 108 processes the data and updates phishing detection models, ensuring that future emails with similar characteristics are more easily identified as phishing attempts across all connected devices. If multiple users report similar emails, the cloud environment 108 may update the local trend data in their database(s) 212. By providing real-time feedback to the cloud environment 108, the method may continuously improve the phishing detection capabilities, enhancing overall security for all users.

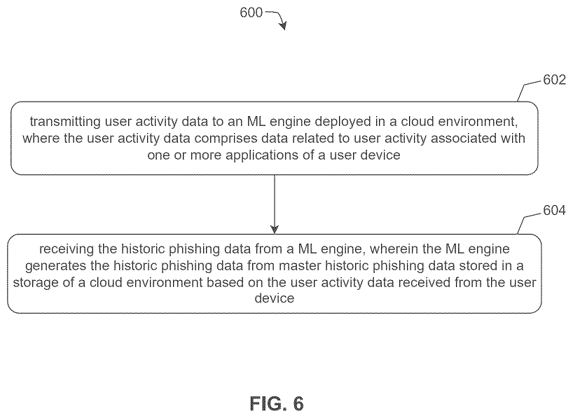

FIG. 6 is a flowchart illustrating a method 600 for retrieving phishing detection data at a user device, according to one or more embodiments of the present disclosure. As already explained above in the description that phishing detection data may include user activity data and the local trend data. Said user activity data and the current location of the user device 102 when transmitted to the cloud environment 108, the historic phishing data and the local trend data may be received from the cloud environment 108 corresponding to each of the user activity data and the current location of the user device 102. In the present embodiment, the user activity data may be considered for retrieving the historic phishing data and the local trend data from the cloud environment 108.

At step 602, method 600 includes transmitting the user activity data to an ML module 214 deployed in the cloud environment 108. The user activity data consists of information related to the user's interactions with various applications on the device. Examples of such user activity include browsing on a specific application, frequent receipt of messages or communications from a particular application, etc. The user activity data may be retrieved based on user interests and browsing history, which is stored in memory 204.

At step 604, method 600 includes receiving at least one of the historic phishing data and the local trend data from the ML module 214. The ML module 214 generates historic phishing data by analysing master historic phishing data stored in databases 212 within the cloud environment 108. Said embodiment includes identifying past phishing threats that align with the user's current activity patterns. Similarly, the ML module 214 generates local trend data by analysing master local trend data from databases 212 based on the user's activity and location. Said embodiment includes providing local trends, events, and associated phishing related patterns user's region or recent attack patterns.

For example, if a user frequently interacts with an online banking application and suddenly receives multiple messages from an unverified sender claiming to be the bank, the ML module 214 processes said user activity. The ML module 214 retrieves historic phishing data related to banking scams and local trend data about recent phishing attempts targeting users in the same geographical area. Said information may be provided to the AI module 108 refine its phishing detection process, ensuring that threats specific to the user's behaviour and region are accurately identified.

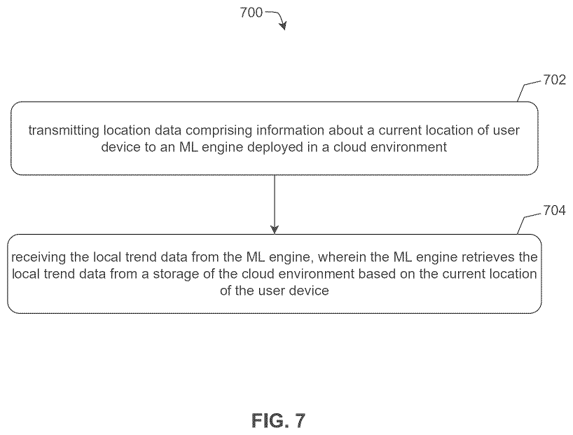

FIG. 7 is a flowchart illustrating a method 700 for retrieving phishing detection data at a user device 102, according to one or more embodiments of the present disclosure. At step 702, the method includes transmitting location data comprising information about the current location of user device 102 to an ML module 210 deployed in the cloud environment 108. Said method focuses on leveraging the location data of the user device to retrieve regional threat patterns, local trend data, and historic phishing data for determining the communication to be phishing communication. When the current location of user device 102 is transmitted to the ML module 214, the ML module 210 may retrieve historic phishing data specific to that country or region from the database(s) 212.

At step 704, the method receiving at least one of the historic phishing data and the local trend data from the ML module 214. In an embodiment, the ML module 214 may generate the historic phishing data from master historic phishing data stored in a database(s) 212 of the cloud environment 108 based on the user activity data received from the user device 102. Further, in an embodiment, the ML module 214 may generate the local trend data from master local trend data stored in the database(s) 212 of the cloud environment 108 based on the user activity data received from the user device 102. When the current location of user device 102 is transmitted to the ML module 214, the ML module 210 may retrieve trending events and their associated phishing trends specific to that country or region from the database(s) 212. Said information may be provided to the AI module 108 refine its phishing detection process, ensuring that threats specific to the user's behaviour and region are accurately identified.

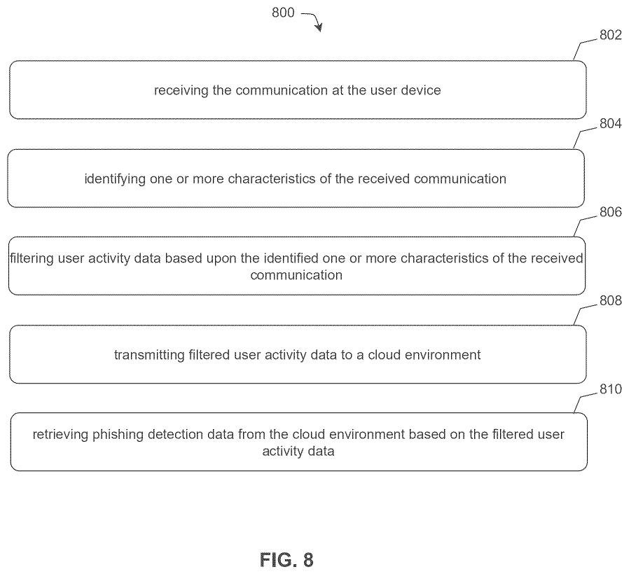

FIG. 8 is a flowchart illustrating a method 800 for filtering communication at a user device, according to one or more embodiments of the present disclosure. Said embodiment may be consider the user activity data that is contextually relevant to a received communication. In an embodiment, the method 800 uses only pertinent user activity information, such as interactions with specific applications or services, to determine the likelihood of the communication being a phishing attempt.

At step 802, the method includes receiving the communication at the user device 102.

Upon receiving the communication, at step 804, one or more characteristics of the communication may be identified, which may include but are not limited to the sender's email address, embedded URLs, message content, and the presence of attachments. Said step may be performed by the processor 202.

At step 806, based on the identified characteristics, user activity data may be filtered to extract only relevant portions that align with the type of the received communication. In an example, the “type of the received communication” may refer to the category or context of the communication, which may help to determine which user activity data to filter. Examples of the type of communication may include but not limited to banking-related communications, e.g., emails or messages about account verification, where relevant activity data could be recent login attempts to online banking portals and interactions with financial service links, e-commerce-related communications, e.g., messages about deliveries or promotional offers, where relevant data could include browsing history and previous order confirmations, social media-related communications, e.g., password reset requests, with relevant data such as logins to social media platforms, or travel or delivery service-related communications, e.g., flight or package notifications, where relevant data may include interactions with travel bookings or delivery services). The processor 202 filters the user activity data based on said types to ensure that only contextually significant data may be transmitted to the cloud environment 108 for retrieval of phishing detection data from the cloud environment 108.

At step 808, the filtered user activity data may be transmitted to the cloud environment 108. In response, at step 810, the cloud environment 108 may retrieve phishing detection data, which includes both historic phishing data and local trend data, based on the filtered user activity data. The ML module 214 in the cloud environment 108 processes the filtered user activity data to retrieve past records of similar phishing attempts. Further, the ML module 214 analyzes emerging phishing trends by correlating reports from multiple users with similar activity patterns. Accordingly, the phishing detection data may be transmitted to the system 104 that may be used in determining the communication to be the phishing attempt.

The advantages of present invention may include detecting and preventing region/global based phishing attempts. Further, the proposed system has It has the potential to identify the possible phishing attack types based on user/victim behaviour, for example, browsing history, user interest, etc. Further, the system continuously learns the latest phishing attacks as well as via feedbacks such as phishing attack confirmed in the user environment, that data is given as feedback to machine learning module for further training. The proposed system ensures that multiple user devices are protected irrespective of their location, via the local agent running on the device. Further the proposed system improves security efforts towards Bring Your Own Device (BYOD) policies.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method of filtering communication at a user device, wherein the method comprises:
receiving a communication at the user device;
retrieving phishing detection data from a cloud environment based on user activity data and a current location of the user device, wherein the phishing detection data comprises historic phishing data and local trend data;
calculating a probability of the communication being a phishing communication based on the retrieved phishing detection data; and
filtering the received communication based on the calculated probability, wherein the filtering comprises at least one of blocking the received communication and displaying the received.

2. The method as claimed in claim 1, wherein the filtering comprises:
blocking the received communication when the calculated probability is above a first threshold;
displaying a warning message corresponding to the received communication when the calculated probability is above a second threshold and below the first threshold; and
allowing the received communication as per a corresponding routine operation when the calculated probability is lower than the second threshold.

3. The method as claimed in claim 2, wherein the method further comprises:
determining the received communication to be the phishing communication when the calculated probability is above the first threshold; and
transmitting information about the phishing communication to the cloud environment.

4. The method as claimed in claim 3, wherein the user device is associated with an enterprise environment, wherein the method further comprises:
transmitting a security warning message to security center of the enterprise environment, wherein the security warning message comprises information about the phishing communication.

5. The method as claimed in claim 1, wherein the retrieving further comprises:
transmitting the user activity data to an ML module deployed in the cloud environment, wherein the user activity data comprises data related to user activity associated with one or more applications of the user device; and
receiving at least one of the historic phishing data and the local trend data from the ML module, wherein the ML module generates the historic phishing data from master historic phishing data stored in a storage of the cloud environment based on the user activity data received from the user device, wherein the ML module generates the local trend data from master local trend data stored in the storage of the cloud environment based on the user activity data received from the user device.

6. The method as claimed in claim 1, wherein the retrieving further comprises:
transmitting location data comprising information about the current location of user device to an ML module deployed in the cloud environment; and
receiving at least one of the historic phishing data and the local trend data from the ML module, wherein the ML module generates the historic phishing data from master historic phishing data stored in a storage of the cloud environment based on the user activity data received from the user device, wherein the ML module generates the local trend data from master local trend data stored in the storage of the cloud environment based on the user activity data received from the user device.

7. The method as claimed in claim 1, wherein the method comprises:
receiving the communication at the user device;
identifying one or more characteristics of the received communication;
filtering user activity data based upon the identified one or more characteristics of the received communication;
transmitting filtered user activity data to a cloud environment; and
retrieving phishing detection data from the cloud environment based on the filtered user activity data.

8. A system for filtering communication, the system comprising:
a storage; and
at least one processor coupled to the storage, the at least one processor configured to:
receive a communication;
retrieve phishing detection data from a cloud environment based on user activity data and a current location of a user device using an AI module, wherein the phishing detection data comprises historic phishing data and local trend data;
calculate a probability of the communication being a phishing communication based on the retrieved phishing detection data; and
filter the received communication based on the calculated probability, wherein the filtering comprises at least one of blocking the received communication and displaying the received.

9. The system of claim 8, wherein the at least one processor is configured to:
block the received communication when the calculated probability is above a first threshold;
display a warning message corresponding to the received communication when the calculated probability is above a second threshold and below the first threshold; and
allow the received communication as per a corresponding routine operation when the calculated probability is lower than the second threshold.

10. The system of claim 9, wherein the at least one processor configured to:
determine the received communication to be the phishing communication when the calculated probability is above the first threshold; and
transmit information about the phishing communication to the cloud environment.

11. The system of claim 10, wherein the at least one processor is configured to:
transmit a security warning message to security center of the enterprise environment, wherein the security warning message comprises information about the phishing communication.

12. The system of claim 8, wherein the at least one processor is configured to:
transmit the user activity data to an ML module deployed in the cloud environment, wherein the user activity data comprises data related to user activity associated with one or more applications of the user device; and
receive at least one of the historic phishing data and the local trend data from the ML module, wherein the ML module generates the historic phishing data from master historic phishing data stored in a storage of the cloud environment based on the user activity data received from the user device, wherein the ML module generates the local trend data from master local trend data stored in the storage of the cloud environment based on the user activity data received from the user device.

13. The system of claim 8, wherein the at least one processor is configured to:
transmit location data comprising information about the current location of user device to an ML module deployed in the cloud environment; and
receiving at least one of the historic phishing data and the local trend data from the ML module, wherein the ML module generates the historic phishing data from master historic phishing data stored in a storage of the cloud environment based on the user activity data received from the user device, wherein the ML module generates the local trend data from master local trend data stored in the storage of the cloud environment based on the user activity data received from the user device.

14. The system of claim 8, wherein the at least one processor is configured to:
receive the communication at the user device;
identify one or more characteristics of the received communication;
filter user activity data based upon the identified one or more characteristics of the received communication;
transmit filtered user activity data to the cloud environment to receive the phishing detection data from the cloud environment; and
retrieve phishing detection data from the cloud environment based on the filtered user activity data.

15. A computer-readable medium having computer-executable instructions stored thereon that, when executed by a processor, cause the processor to:
receive a communication;
retrieve phishing detection data from a cloud environment based on user activity data and a current location of a user device, by an AI module, wherein the phishing detection data comprises historic phishing data and local trend data;
calculate a probability of the communication being a phishing communication based on the retrieved phishing detection data; and
filter the received communication based on the calculated probability, wherein the filtering comprises at least one of blocking the received communication and displaying the received.

16. The computer-readable medium of claim 15, wherein the computer-executable instructions cause the processor to:
block the received communication when the calculated probability is above a first threshold;
display a warning message corresponding to the received communication when the calculated probability is above a second threshold and below the first threshold; and
allow the received communication as per a corresponding routine operation when the calculated probability is lower than the second threshold.

17. The computer-readable medium of claim 16, wherein the computer-executable instructions cause the processor to:
determine the received communication to be the phishing communication when the calculated probability is above the first threshold; and
transmit information about the phishing communication to the cloud environment.

18. The computer-readable medium of claim 17, wherein the computer-executable instructions cause the processor to:
transmit a security warning message to security center of the enterprise environment, wherein the security warning message comprises information about the phishing communication.

19. The computer-readable medium of claim 15, wherein the computer-executable instructions cause the processor to:
transmit the user activity data to an ML module deployed in the cloud environment, wherein the user activity data comprises data related to user activity associated with one or more applications of the user device; and
receiving at least one of the historic phishing data and the local trend data from the ML module, wherein the ML module generates the historic phishing data from master historic phishing data stored in a storage of the cloud environment based on the user activity data received from the user device, wherein the ML module generates the local trend data from master local trend data stored in the storage of the cloud environment based on the user activity data received from the user device.

20. The computer-readable medium of claim 15, wherein the computer-executable instructions cause the processing system to:
transmit location data comprising information about the current location of user device to an ML module deployed in the cloud environment; and
receiving at least one of the historic phishing data and the local trend data from the ML module, wherein the ML module generates the historic phishing data from master historic phishing data stored in a storage of the cloud environment based on the user activity data received from the user device, wherein the ML module generates the local trend data from master local trend data stored in the storage of the cloud environment based on the user activity data received from the user device.
